(19) United States
(12) Patent Application Publication
(10) Pub. No.: US 2003/0201874 A1
(43) Pub. Date: Oct. 30, 2003

(54) Shrew-expelling device with illuminating function

(76) Inventor: Chih-Hsien Wu, Taipei (TW)

Correspondence Address: TROXELL LAW OFFICE PLLC, 5205 LEESBURG PIKE, SUITE 1404, FALLS CHURCH, VA, 22041, US

(21) Appl. No.: 10/128,300

(22) Filed: Apr. 24, 2002

(51) Int. Cl. G08B 3/10

(52) U.S. Cl. 340/384.2; 340/573.2

(57) ABSTRACT

A shrew-expelling device with an illumination function, the device is comprised of an electric circuitry, a main stem and a housing; wherein, the electric circuitry includes a power supplying circuit, a sound emitting circuit and a light emitting circuit, the power supplying circuit generates electricity in taking advantage of a solar-energy powered electricity generating element. The device with a buzzer and a light emitting element therein makes sound which is abominated by rodents and illuminates respectively; and thereby, the device has an effect of expelling rats and illuminating; wherein, by providing various modeling formed from a housing and a main stem, the device can completely immersed into the scenery of the environment to even beautify the latter.

### BACKGROUND OF THE INVENTION

1. Field of the Invention

The present invention is related to a shrew-expelling device with an illumination function, and especially to such a device which can generate electricity taking advantage of solar energy to make illumination of a light emitting element and make sound of a buzzer, which sound is abominated by rodents; and thereby, the device has an effect of expelling rats and illuminating, it is particularly suitable for use at the spots of courtyards, parks or the like.

2. Description of the Prior Art

According to domestic and foreign reports of studies, rodents hiding in the soil are extremely sensitive to sound waves with frequencies below 1000 Hz, therefore, a conventional shrew-expelling device includes mainly: a main stem, which stem is a hollow pipe, one end thereof is a sharpened end, while the other end thereof is externally threaded and knurled; a cover of which the two lateral sides are provided each with a lug, the cover is provided internally with a thread; a battery receiving seat, the seat is provided on one end thereof with a hole; an acoustic-frequency vibration electric circuit for generating acoustic frequencies, a lug is provided on the electric circuit; and a washer. The lug provided on the acoustic-frequency vibration electric circuit is engaged in the hole of the battery receiving seat and then the acoustic-frequency vibration electric circuit is placed in the main stem, and the cover and the washer are put on for sealing; the main stem is inserted with its sharpened end into the soil. By vibration of the acoustic-frequency generated by the acoustic-frequency vibration electric circuit through the main stem, an effect of rodent expelling can be provided. However, the device can only expel shrews, it needs to change batteries after a period of time, the batteries out of electricity do not have the effect of rodent expelling, hence it can not afford a long time use; and the batteries can not meet the requirement of environmental conservation. The device even is harmful to the scenery of a courtyard, and thereby is not an ideal device.

### SUMMARY OF THE INVENTION

In view of this, the inventor of the present invention provides a shrew-expelling device with an illumination function, wherein, by combination of a shrew-expelling device with an illuminating lamp by means of an electric circuitry, a double function of shrew expelling and illumination can be obtained.

The primary object of the present invention is to provide a shrew-expelling device with an illumination function, wherein, the device can generate electricity in taking advantage of solar energy; such mode of energy obtaining does not make a burden to the environment to thereby provide an effect of environmental conservation. And the device can be used for a long time; it will not lose the effect of shrew expelling by being out of electricity.

The secondary object of the present invention is to provide a shrew-expelling device with an illumination function, wherein, by providing various modeling formed from a housing and a main stem, the device can completely immersed into the scenery of the environment to even beautify the latter.

Therefore, in order to obtain the above stated objects, the present invention is comprised of an electric circuitry, a housing and a main stem; wherein, by providing a power supplying circuit, a sound emitting circuit and a light emitting circuit on the electric circuitry, the device can generate electricity in taking advantage of solar energy to make illumination of a light emitting element and make sound of a buzzer of which the sound waves are abominated by rodents, thereby, an effect of expelling rats and illuminating can be provided. And by providing modeling formed from the housing and the main stem, the device can completely immersed into the scenery of the environment to even beautify the latter.

The present invention will be apparent in its structure and features after reading the detailed description of the preferred embodiment thereof in reference to the accompanying drawings.

### BRIEF DESCRIPTION OF THE DRAWINGS

FIG. 1ais a perspective view showing the appearance of a preferred embodiment of the present invention;

FIG. 1b is a perspective view showing the appearance of a preferred embodiment of the present invention from another angular position;

FIG. 2 is an analytic perspective view showing the elements of the preferred embodiment of the present invention;

FIG. 3 is an electric circuit diagram of the preferred embodiment of the present invention;

FIG. 4 is a sectional view of the preferred embodiment of the present invention.

### DETAILED DESCRIPTION OF THE PREFERRED EMBODIMENT

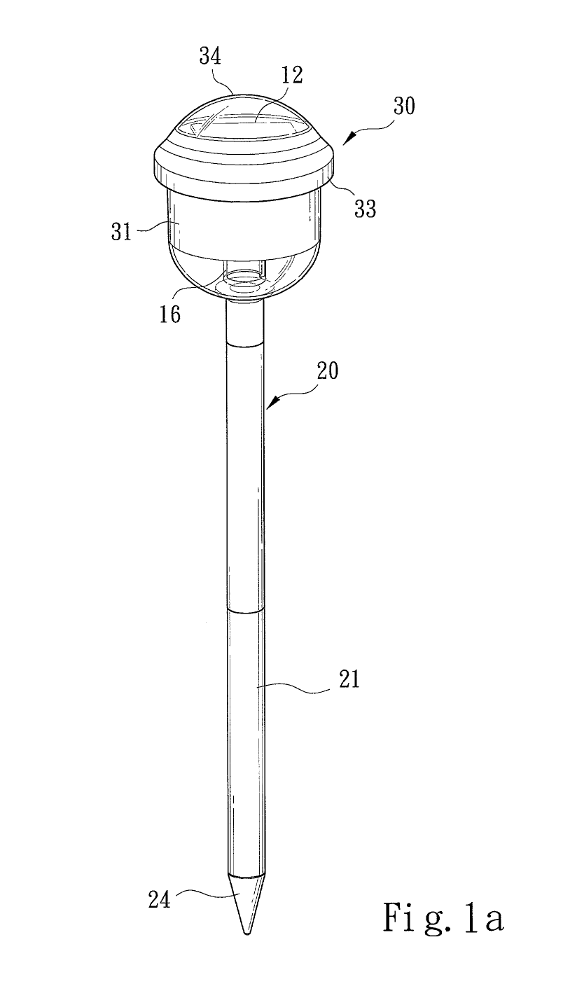

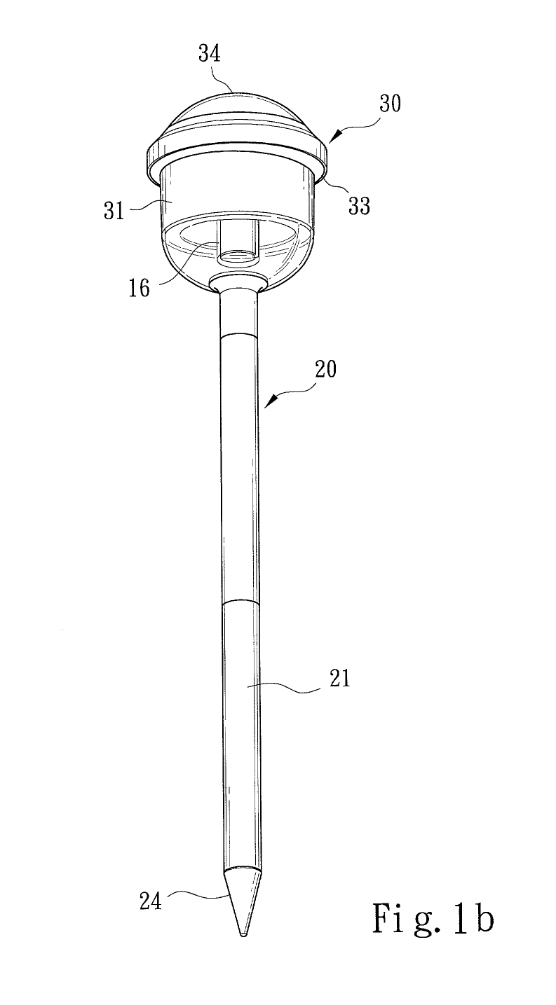

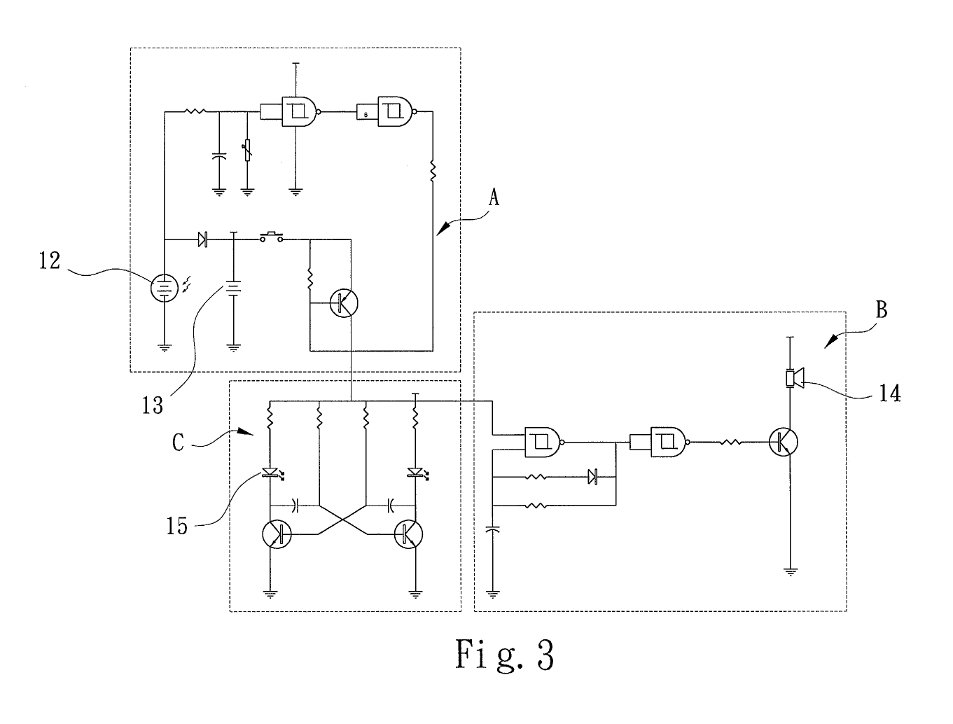

Referring firstly to FIGS. 1a-3, the shrew-expelling device with an illumination function of the present invention is comprised of an electric circuitry 10, a main stem 20 and a housing 30.

Wherein, the electric circuitry 10 has an electric circuit board 11 and includes a power supplying circuit “A”, a sound emitting circuit “B” and a light emitting circuit “C”. The power supplying circuit “A” can generate electricity in taking advantage of a solar-energy powered electricity generating element 12; the power is stored in a rechargeable battery 13. The sound emitting circuit “B” generates signals in taking advantage of the electric circuit board 11 to make sound of a buzzer 14 which emits sound waves with frequencies below 1000 Hz; while the light emitting circuit “C” is powered by the rechargeable battery 13 to make illumination of a light emitting element 15.

The main stem 20 is made from a plurality of hollow rods 21, a socket is provided therein for connecting of electric wires; each rod 21 is provided on one end thereof with a connecting portion 23 to allow connecting of every two neighboring rods 21 by slipping one over the other; the last rod 24 of the main stem 20 is in the form of a cone for inserting into the soil.

The housing 30 is provided with a transparent lamp shade 31 in the form of a bowel, the lamp shade 31 is provided on the bottom thereof with a connecting pipe 32 to be connected with a connecting portion 23 of a rod 21 of the main stem 20, thereby, the lamp shade 31 is connected with the main stem 20; and the lamp shade 31 is provided on the top thereof with an annular connecting cover 33 which is connected on the top thereof with a transparent semispherical hood 34. The lamp shade 31 of the housing 30 and the connecting cover 33 are provided therein with an electric circuit base 35 for fixing the electric circuit board 11 and a power generating base 36 for mounting a power generating element 12 to generate electricity in taking advantage of solar energy. The electric circuit base 35 and the power generating base 36 are provided therebetween with a battery seat 22 to receive the rechargeable battery 13. The electric circuit base 35 is provided therebeneath with an inner lamp shade 16 and a light-emitting element seat 37, the bottom of the inner lamp shade 16 is plated with light reflecting material to reflect the light from the light emitting element 15. The light-emitting element seat 37 is provided for receiving the light emitting element 15.

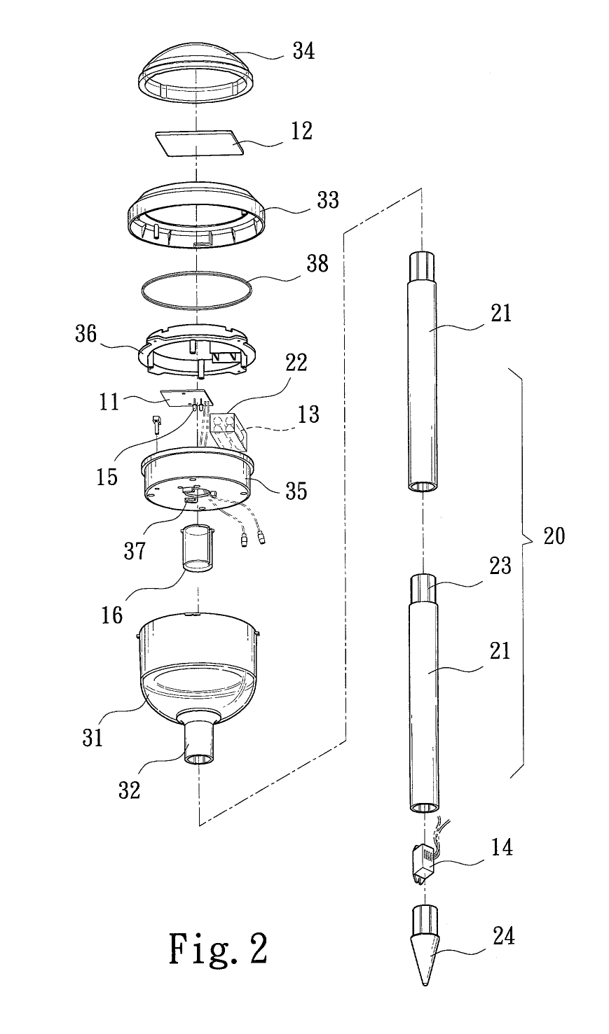

Referring to FIG. 2, when in assembling of the present invention, the battery seat 22, the electric circuit board 11 and the solar-energy powered electricity generating element 12 are respectively thread connected with the electric circuit base 35 and the power generating base 36, and then are placed in the lamp shade 31, they are combined with the lamp shade 31 when the transparent hood 34 and the annular connecting cover 33 are engaged with each other, then a washer 38 is sealed thereon; and lastly, the buzzer 14 is embedded in the tip end of the last rod 24, the stems 21 are sequentially connected and connected with the connecting pipe 32 provided on the bottom of the lamp shade 31 to form the main stem 20. With the above assembly, the shrew-expelling device with an illumination function of the present invention is completed.

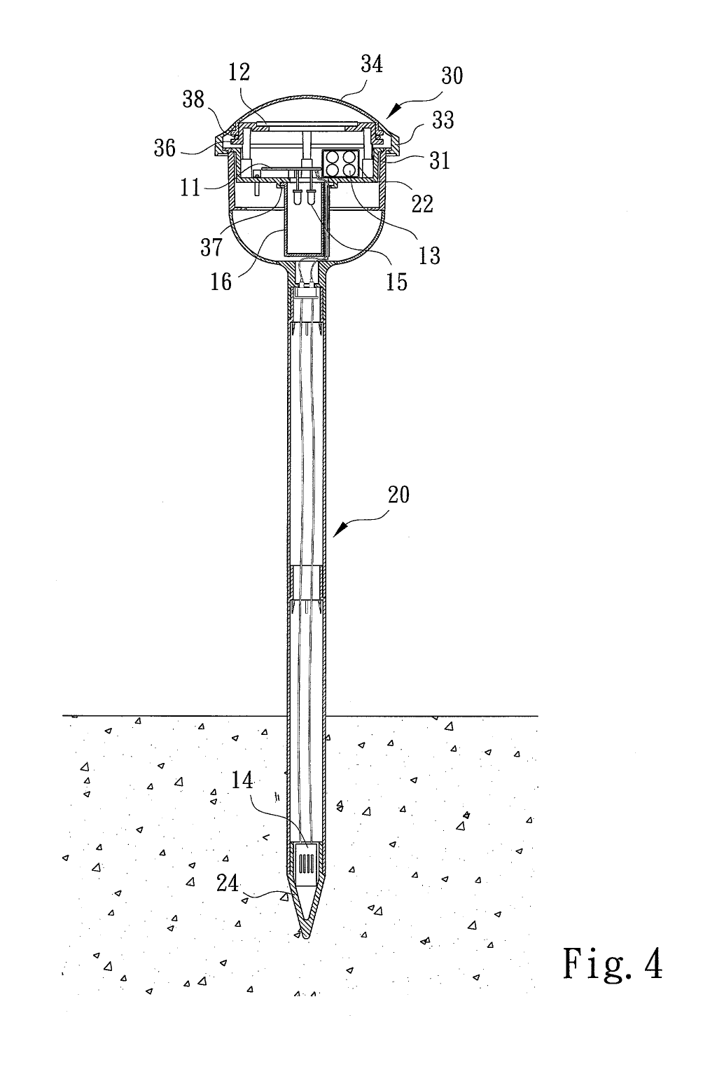

Referring to FIG. 4, when in using of the present invention, it needs only to insert the present invention into the soil firmly, when it is irradiated by the sun light in the daytime, by transparency of the transparent hood 34 mounted on the housing 30, the solar-energy powered electricity generating element 12 generates power by irradiation of the sun light, the electric energy is stored in the rechargeable battery 13 ready for use by the buzzer 14 and the light emitting element 15. When in a particular time (such as at night), the buzzer 14 and the light emitting element 15 will automatically activated to generate low frequency sounds that the rodents abominate and to generate illumination, thereby, they can provide the effect of expelling rats and illuminating.

The sound emitting circuit “B” of the electric circuitry 10 of the present invention can be set to make sound intermittently, for instance, it is activated to sound for 3-5 seconds every 30 seconds. In this way, power can be effectively saved to increase the available time of use; and can avoid the rats adapting to the sounds by sounding a long time by the buzzer 14, which case may make losing of the effect of rat expelling.

And more, the present invention can be provided with a plurality of light emitting elements 15 capable of providing different colors, by intercrossing light emitting, various light colors and flashing effects can be generated; further, the housing 30 and the main stem 20 can have quite a many changes of modeling; the present invention can thereby increase beauty as well as mood in cooperating with the circumstance it is located. The function of shrew-expelling or illumination will not make harm to the scenery of a courtyard, and thereby the present invention is practicable.

Therefore, the present invention has the following advantages:

1. The present invention can generate electricity in taking advantage of solar energy; it does not make a burden to the environment to thereby provide an effect of environmental conservation. And the device can be used for a long time, it will not lose the effect of shrew expelling by being out of electricity of the batteries thereof, thereby the present invention is practicable in use.

2. In the present invention, by combination of a shrew-expelling device with an illuminating lamp by means of an electric circuitry, a double function of shrew expelling and illumination can be obtained, thereby the present invention is convenient in use.

3. The housing and the main stem of the present invention can have quite a many changes of modeling; the present invention can be completely immersed into the scenery of the environment to even beautify the latter.

The present invention not only can get rid of the defect resided in the conventional shrew-expelling device, but also can get an double effect of environmental conservation in a long time use by providing electricity in taking advantage of solar energy to make illumination of a light emitting element and of making sound of a buzzer for shrew expelling. Thereby, the practicability and convenience of the entire device of the present invention is largely increased, it can be used in the scenery of a courtyard, a park or the like.

The above statement is only for illustrating a preferred embodiment of the present invention, and not for giving any limitation to the scope of the present invention. It will be apparent to those skilled in this art that various modifications or changes without departing from the spirit, scope and characteristic of this invention can fall within the scope of the appended claims and are intended to form part of this invention.

Having thus described the present invention with industrial value, what I claim as new and desire to be secured by Letters Patent of the United States are:

1. A shrew-expelling device with an illumination function, said device is comprised of an electric circuitry, a main stem and a housing; wherein,
said electric circuitry includes a power supplying circuit, a sound emitting circuit and a light emitting circuit, said power supplying circuit generates electricity in taking advantage of a solar-energy powered electricity generating element, the power is stored in a rechargeable battery; said sound emitting circuit generates signals in taking advantage of said sound emitting circuit to make sound of a buzzer which emits sound waves with frequencies below 1000 Hz; while said light emitting circuit is powered by said power supplying circuit to make illumination of a light emitting element;
said main stem is a hollow stem, said main stem is provided on the top end thereof with a connecting portion to connect said housing; the bottom end of said main stem is in the form of a cone for inserting of said main stem into the soil;
said housing has a receiving space therein to receive said electric circuitry, and is provided on the bottom thereof with a connecting pipe to be cooperated in connection with said connecting portion of said main stem, thereby, said housing is connected with said main stem;
said electric circuitry is combined in said main stem and said housing, and said connecting pipe of said housing is engaged and connected with said connecting portion on said top end of said main stem, thus said shrew-expelling device with an illumination function is completed.

2. The shrew-expelling device with an illumination function as in claim 1, wherein,
said main stem is made from a plurality of hollow rods, each of said rods is provided on one end thereof with a connecting portion to allow connecting of every two neighboring ones of said rods by slipping one over the other; a socket is provided in each of said connecting portions for connecting of electric wires.

3. The shrew-expelling device with an illumination function as in claim 1, wherein,
said housing is provided with a transparent lamp shade in the form of a bowel, and is provided on the top thereof with an annular connecting cover which is connected on the top thereof with a transparent semispherical hood; a lamp shade and said connecting cover of said housing are provided therein with an electric circuit base for fixing said electric circuitry and a power generating base for mounting a power generating element to generate electricity in taking advantage of solar energy, said electric circuit base is s provided therebeneath with an inner lamp shade and a light-emitting element seat to receive said light emitting element and to reflect light.

4. The shrew-expelling device with an illumination function as in claim 1, wherein,
said buzzer in said electric circuitry is embedded in the bottom end of said main stem.

5. The shrew-expelling device with an illumination function as in claim 1, wherein,
said buzzer is set to make sound intermittently.
